(19) United States
(12) Patent Application Publication
(10) Pub. No.: US 2014/0129633 A1
(43) Pub. Date: May 8, 2014

(54) INTERACTION SYSTEM AND INVESTIGATION METHOD

(71) Applicant: WISTRON CORPORATION, New Taipei City (TW)

(72) Inventors: Mei-Man Chen, New Taipei City (TW); Yu-Yen Chen, New Taipei City (TW)

(73) Assignee: Wistron Corporation, New Taipei City (TW)

(21) Appl. No.: 13/891,210

(22) Filed: May 10, 2013

(30) Foreign Application Priority Data
Nov. 5, 2012 (TW) 101140970

(51) Int. Cl. H04L 29/06

(52) U.S. Cl. CPC H04L 65/403
USPC 709/204

(57) ABSTRACT

An interaction system includes a primary interaction device, for receiving a digital stream content and action information and combining the action information, content information of the digital stream content corresponding to the action information and device information to generate combination information. The interaction system also includes a secondary interaction device, for receiving interaction information of an interactive network service and performing an action of the interactive network service to generate the action information; and a server module, which includes a data base; a playing server, for generating the digital stream content; and a data managing server, for receiving the combination information to transfer the action information to the interactive network service, and storing the combination information and the interaction information in the data base.

### BACKGROUND OF THE INVENTION

1. Field of the Invention

The present invention relates to an interaction system and an investigation method, and more particularly, to an interaction system and an investigation method capable of increasing the enjoyment of users while watching digital stream content via interactive network services.

2. Description of the Prior Art

With their ability to improve home entertainment options by increasing the usage functions of televisions, smart TVs are becoming more and more popular. A standard smart TV includes interfaces for connecting to the Internet. Via launchers (applications) displayed on the screen, the smart TV allows a user to play digital stream contents by launching certain Internet stream applications (such as YouTube) and to acquire information through the world-wide web by launching other Internet applications.

Conventionally, most applications of the smart TV are transplanted from other platforms, such as smart phones or tablets. In other words, applications utilize the smart TV as a display device capable of connecting to the Internet. This means that the applications are not designed to demonstrate unique advantages of the smart TV; in some cases they can even highlight disadvantages of the smart TV.

For example, when the user launches an interactive network service application on the smart TV, such as Facebook or twitter, the interactive network service application displays the content of the interactive network service on the smart TV in the display mode best fitted to the specifications of the smart TV. The interactions between the user and the interactive network service, such as typing, are performed via the remote control. Since the user is typically positioned at a certain distance from the smart TV, there may be some inconvenience when looking at content of the interactive network service, such as instructions related to articles or pictures. Moreover, the remote control is not a suitable device for performing interactions between the user and the interactive network service, which further adds to the inconvenience caused to the user.

Since the user acquires digital stream contents from the Internet in the current interaction method, the industry which provides the digital stream content cannot effectively acquire feedback from the user by interacting with the user through the smart TV. The industry therefore cannot determine whether the user has actually viewed the digital content or what impression they have of said digital content. At present, if the industry wishes to interact with the user, interaction contents need to be embedded in the digital stream content, which means that cost and complexity of producing the digital stream content are significantly increased.

### SUMMARY OF THE INVENTION

Therefore, the present invention aims to provide an interaction system and investigation method capable of improving the enjoyment of watching digital stream content so as to enhance the overall user experience. The digital stream content provider can also acquire information from the user via interactions between the user and the interactive network service, which further enhances the user experience.

The present invention discloses an interaction system. The interaction system includes a primary interaction device, for receiving a digital stream content and action information and combining the action information, content information of the digital stream content corresponding to the action information and device information to generate combination information; a secondary interaction device, for receiving interaction information of an interactive network service and performing an action of the interactive network service to generate the action information; and a server module, comprising a data base; a playing server, for generating the digital stream content; and a data managing server, for receiving the combination information to transfer the action information to the interactive network service, and storing the combination information and the interaction information in the data base.

The present invention further discloses an investigation method of an interaction system for generating analysis data. The investigation method includes receiving a digital stream content and interaction information for displaying the digital stream content and an interactive network service corresponding to the interaction information; generating action information when an action of the interactive network service is performed; combining the action information, content information of the digital steam content corresponding to the action information and device information for generating combination information; uploading the combination information to a server module; transmitting the action information to the interactive network service by the server module; and analyzing the combination information, for generating the analysis data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an interaction system according to an embodiment of the present invention.

FIG. 2 is a flow chart of a start procedure according to an embodiment of the present invention.

FIG. 3A and FIG. 3B are schematic diagrams of exemplary embodiments of the data stored in the data base shown in FIG. 1.

FIGS. 4A-4C are schematic diagrams of exemplary embodiments of the analysis data generated by the determining unit shown in FIG.

FIG. 5 is a flow chart of another start procedure according to an embodiment of the present invention.

FIG. 6 is a flow chart of an investigation method according to an embodiment of the present invention.

### DETAILED DESCRIPTION

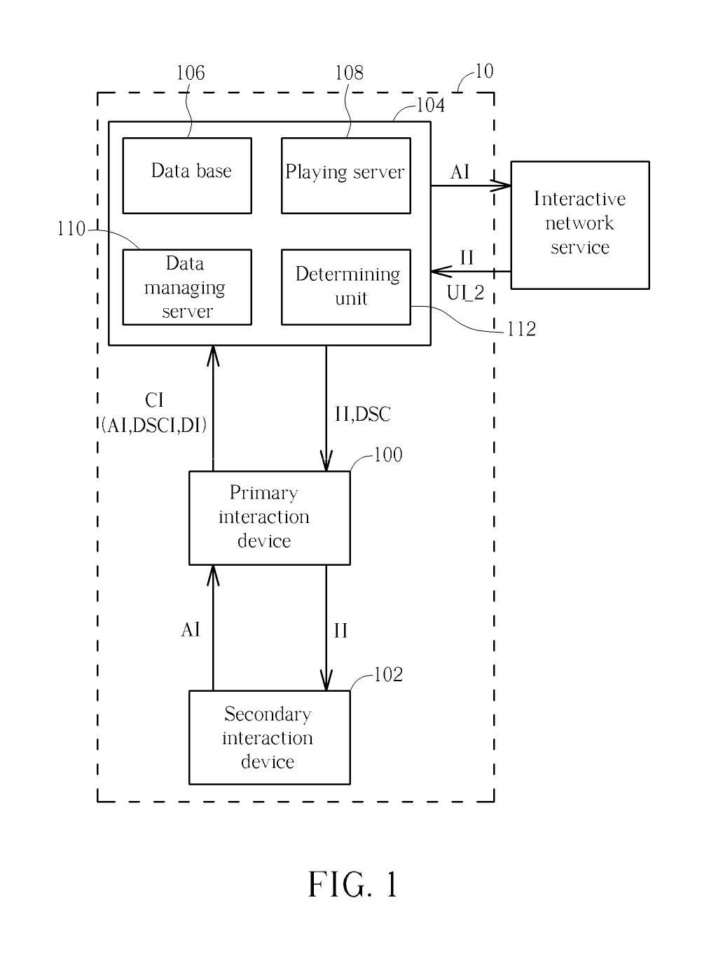

Please refer to FIG. 1, which is a schematic diagram of an interaction system 10 according to an embodiment of the present invention. The interaction system 10 is utilized for allowing a user to interact with others in interactive network services (ex. social networks such as Facebook and Twitter) while watching digital stream contents. Via the interaction system 10, the digital stream content provider can analyze the correlations between the interactions of the user performed on the interactive network services and the digital steam content, so as to provide a unique user experience. As shown in FIG. 1, the interactive system 10 includes a primary interaction device 100, a secondary interaction device 102 and a server module 104. The primary interaction device 100 is an electronic device capable of connecting to the Internet, such as a smart TV or a set-top box, and is not limited herein. The primary interaction device 100 is utilized for performing a primary mode of an application, to receive and to display a digital stream content DSC. When receiving action information AI, the primary interaction device 100 combines the action information AI, content information DSCI of the instantaneous digital stream content DSC and device information DI corresponding to the primary interaction device 100, for generating combination information CI.

The secondary interaction device 102 is an electronic device capable of connecting to the Internet. The secondary interaction device 102 is utilized for performing a secondary mode corresponding to the primary mode of the application, to receive interaction information II from the interactive network service so as to display the information of the interactive network service. For example, the secondary interaction device 102 may display a message board related to the digital stream content DSC or the personal page of the user in the interactive network service. The secondary interaction device 102 is further utilized for performing an action of the interactive network service, such as leaving messages or ‘liking’ a comment/post, to generate the action information AI. Preferably, the secondary interaction device 102 is a handheld mobile electronic device capable of connecting to the Internet, such as a smart phone and a tablet, for allowing the user to conveniently interact with others in the interactive network service. Notably, the secondary interaction device 102 is also capable of performing the primary mode of the application according to system requirements.

The server module 104 includes a database 106, a playing server 108, a data managing server 110 and a determining unit 112, and is utilized for receiving the combination information CI to acquire user information UI_{—}1 corresponding to the user according to the device information DI of the combination information CI. After acquiring the user information UI_{—}1, the server module 104 stores the combination information CI and the user information UI_{—}1. The server module 104 further transmits the action information AI of the combination information CI to the interactive network service. The server module 104 may analyze the stored data for acquiring analysis data corresponding to the digital stream content DSC. Via the interaction system 10, the user can enter an interaction mode for interacting with others via the interactive network service, which can increase the enjoyment of the user while watching the digital stream content. Since the server module 104 stores the combination information CI (i.e. the action information AI, the content information DSCI and the device information DI) and the user information UI_{—}1, the digital stream content provider can learn the real reactions of the user towards the digital stream content through analyzing combination information CI and the user information UI_{—}1 from multiple users. The digital stream content provider can thereby offer a unique user experience according to the habits of the user.

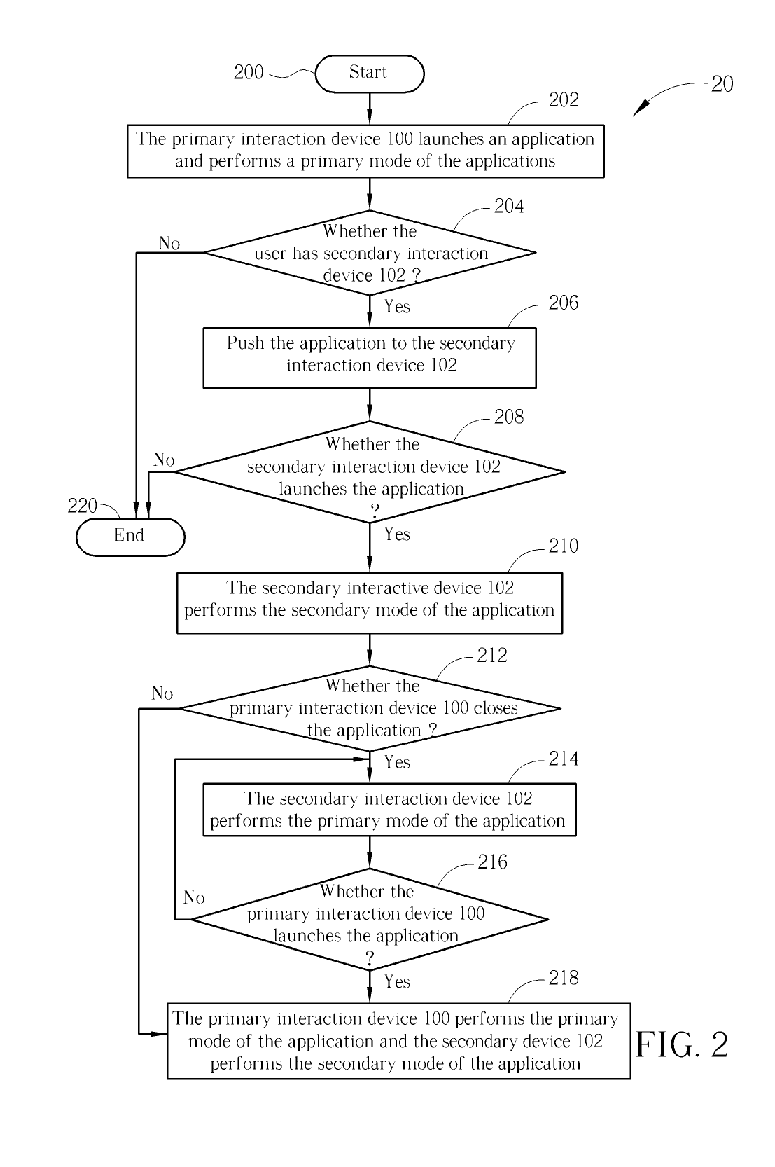

In detail, since both the primary interaction device 100 and the secondary interaction device 102 can perform the primary mode and the secondary mode of the application, the primary interaction device 100 may execute a start procedure when the interaction system 10 begins to operate, for ensuring the primary mode and the secondary mode are performed by the primary interaction device 100 or the secondary interaction device 102. In this embodiment, the primary mode of the application is utilized for receiving and displaying the digital stream content DSC and the secondary mode of the application is utilized for receiving and displaying the interactive network service corresponding to the digital stream content DSC (ex. a FaceBook message board or a chat room of the digital stream content), but this is not limited herein. For example, the primary mode of the application may also display the interactive network service via marquees or display windows while displaying the digital stream content. Please refer to FIG. 2, which is a flow chart of a start procedure 20 according to an embodiment of the present invention. As shown in FIG. 2, the start procedure 20 includes the following steps:

Step 200: Start.

Step 202: The primary interaction device 100 launches an application and performs a primary mode of the applications.

Step 204: Check whether the user has secondary interaction device 102. If the user has the secondary interaction device 102, perform step 206.

Step 206: Push the application to the secondary interaction device 102.

Step 208: Determine whether the secondary interaction device 102 launches the application. Perform step 210 if the secondary interactive device 102 launches the application.

Step 210: The secondary interactive device 102 performs the secondary mode of the application.

Step 212: Detect whether the primary interaction device 100 closes the application. If the primary interaction device 100 closes the application, perform step 214; otherwise, perform step 220.

Step 214: The secondary interaction device 102 performs the primary mode of the application.

Step 216: Detect whether the primary interaction device 100 launches the application. If the primary interaction device 100 launches the application, perform step 218; otherwise, perform step 214.

Step 218: The primary interaction device 100 performs the primary mode of the application and the secondary interaction device 102 performs the secondary mode of the application.

Step 220: End.

The detailed operations of the start procedure 20 are described as follows. First, when the primary interaction device 100 launches the application and operates in the primary mode of the application, the primary interaction device 100 will check whether the user has the secondary interaction device 102 (steps 202, 204). Please note that the interaction system 10 may include multiple secondary interaction devices 102. If the user has the secondary interaction device 102, the primary interaction device 100 pushes the application to the secondary interaction device 102 (step 206). When the secondary interaction device 102 launches the application, the secondary interaction device 102 operates the secondary mode of the application (steps 208, 210). While the interaction system 10 operates, the interaction system 10 will continuously examine whether the primary interaction device 100 closes the application (step 212). When the primary interaction device 100 closes the application, the secondary interaction device 102 is switched to perform the primary mode of the application. Next, the interaction system 10 continuously examines whether the primary interaction device 100 launches the application (step 216). When the primary interaction device 100 launches the application again, the primary interaction device 100 performs the primary mode of the application and the secondary interaction device 102 performs the secondary mode of the application (step 218). Through the start procedure 20, the interaction system 10 can determines the primary mode and the secondary mode of the application are performed by the primary interaction device 100 or the secondary interaction device 102. Please note that the following descriptions are based on the primary interaction device 100 performing the primary mode of the application and the secondary interaction device 102 performing the secondary mode of the application for simplifying instructions.

Next, the primary interaction device 100 begins to receive and to display the digital stream content DSC generated by the playing module 108 of the server module 104. The secondary interaction device 102 begins to receive the interaction information II through the primary interaction device 100, for displaying the interactive network service corresponding to the current digital stream content DSC. When the user performs the actions of the interactive network service, such as leaving messages and ‘liking’ content, the secondary interaction device 102 transmits the action information AI corresponding to the actions to the primary interaction device 100. The action information AI can be the information related to the actions of the interactive network service, such as a name of the user and the message content. After receiving the action information AI, the primary interaction device 100 combines the action information AI, the content information DSCI related to the digital stream content DSC and the device information DI related to the primary interaction device 100, for generating the combination information CI. Then, the primary interaction device 100 transmits the combination information CI to the server module 104. Please note that the content information DSCI may be the playing information of the digital stream content DSC and the name of the digital stream content DSC while the action information AI is generated and the device information DI may be the Internet protocol address (i.e. the IP address) or the product serial number of the primary interaction device 100, but this is not limited herein.

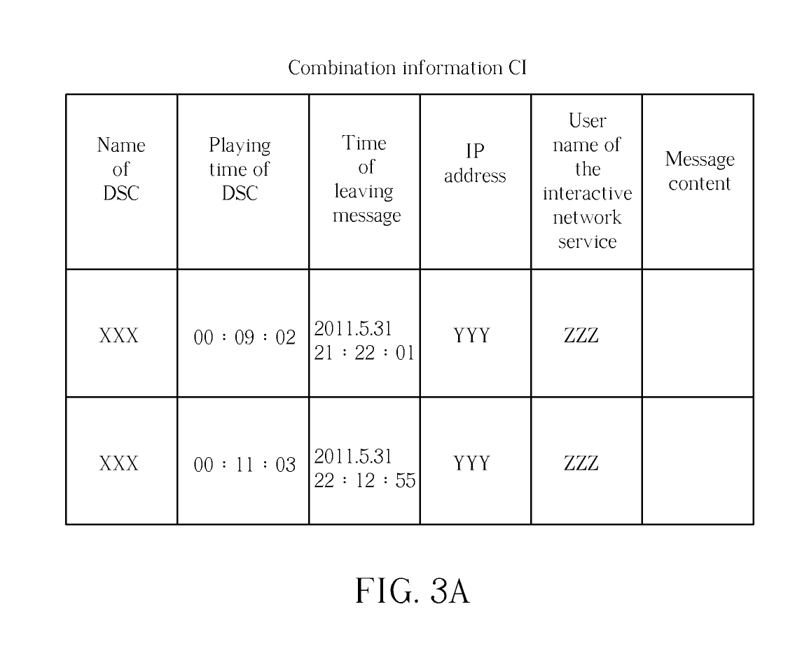

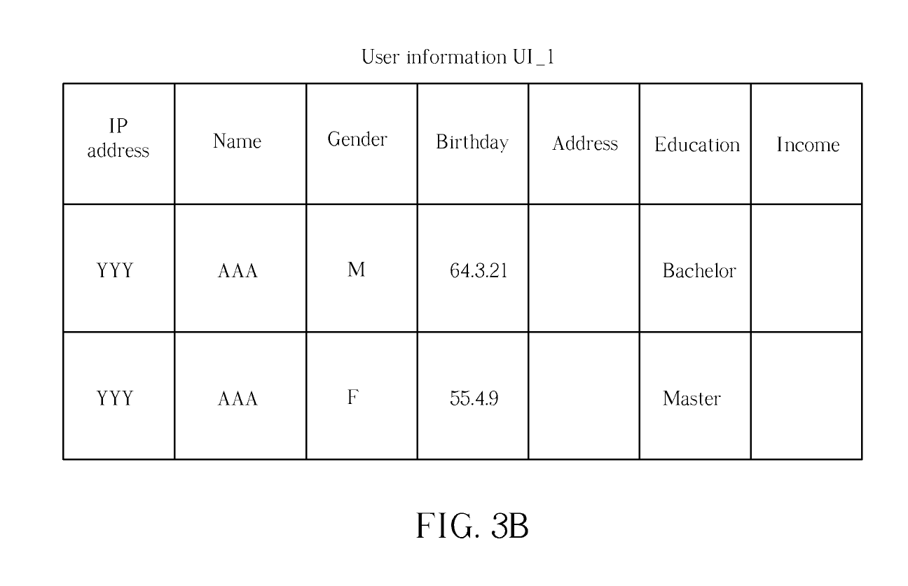

After receiving the combination information CI, the data managing server 110 of the server module 104 firstly transmits the action information AI of the combination information CI to the interactive network service, for executing the actions performed by the user on the interactive network service. The data managing server 110 inquires which data is registered by the user from the digital stream content provider, for acquiring the user information UI_{—}1 according to the device information DI. Then, the data managing server 110 stores the user information UI_{—}1, the combination information CI and the interaction information II in the data base 106, for further analysis. The user information UI_{—}1 may include personal information of the user, such as age, gender, work, education, date of birth, address, etc. Please refer to FIG. 3A and FIG. 3B, which are schematic diagrams of exemplary embodiments of the data stored in the data base 106. As shown in FIG. 3A, the combination information CI stored in the data base 106 might include the name of the digital stream content DSC, the playing time of the digital stream content DCS when the message is generated, the real time of leaving the message, the IP address of the primary interaction device, the user name of the interactive network service and the message content. As shown in FIG. 3B, the user information stored in the data base 106 may include the IP address of the primary interaction device 100, the name, gender, the date of birth, the address, and the education of the user.

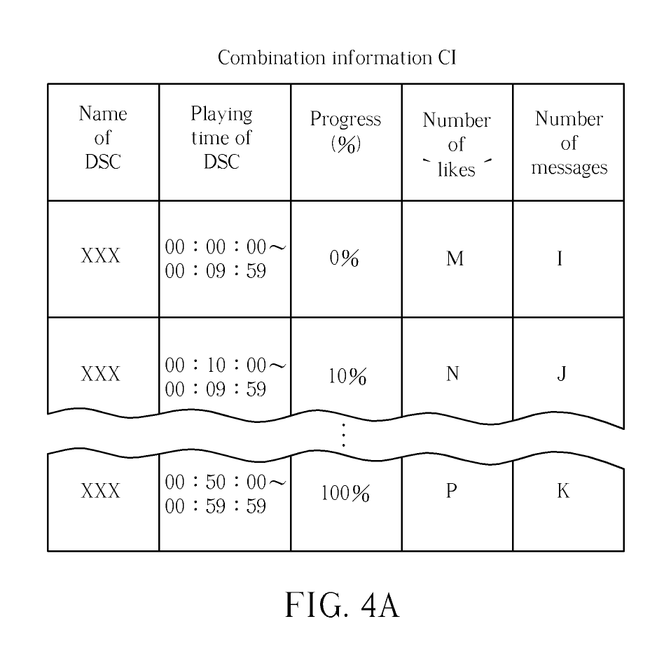

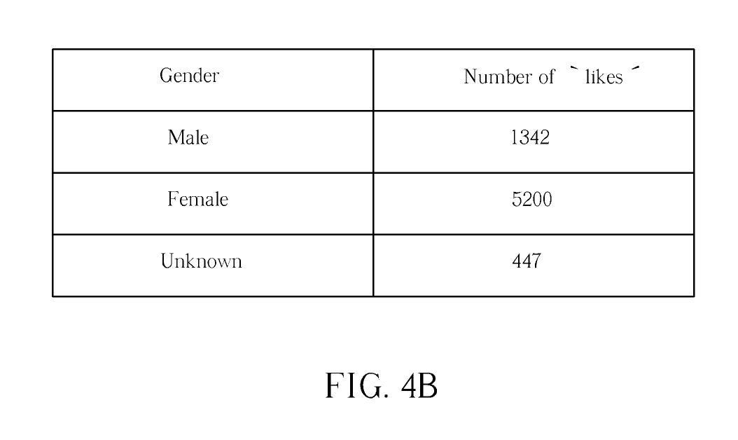

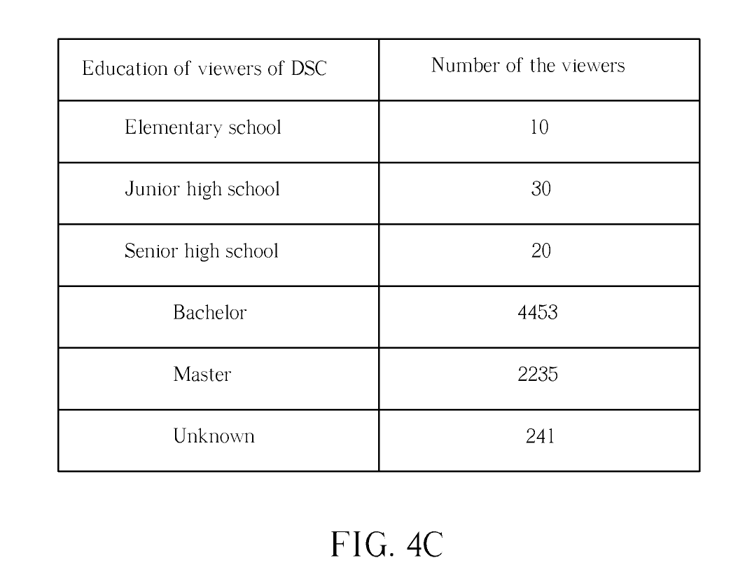

In addition, the data managing server 110 may also acquire more detailed user information UI 2 from the interactive network service via the Internet, for completing the user information stored in the data base 106. According to the data stored in the data base 106, the determining unit 112 can generate precise analysis data. Please refer to FIGS. 4A-4C, which are schematic diagrams of exemplary embodiments of the analysis data generated by the determining unit 112. As shown in FIG. 4A, the analysis data can be the number of ‘likes’ and the number of messages corresponding to each part of the digital stream content DSC. Or, the analysis data can be the relationship between the number of ‘likes’ and the gender of the user as shown in FIG. 4B. Please refer to FIG. 4C, which illustrates that the digital stream content provider can also get the analysis data which shows the education of the viewers of the digital stream content DSC.

According to the data stored in the data base 106, the determining unit 112 may generate various analysis data to the digital stream content provider. Please note that the action information AI becomes correlated to the digital stream content DSC, thus the analysis data generated by the determining unit 112 can be closer to the actual situation of the user. Similarly, the data managing server 110 may store the correlation between the interaction information II and the digital stream content DSC (ex. the playing time of the digital stream content when the interaction information II is generated), thus the digital stream content provider can acquire real reactions of the user corresponding to the digital stream content according to the analysis data generated by the determining unit 112.

Since the interactive network service corresponding to the digital stream content DSC is displayed by the secondary interaction device 102, the user can easily interact with others through the interactive network service while watching the digital stream content DSC on the primary interaction device 100. Furthermore, since the action information AI generated by the secondary interaction device 102 is transmitted to the server module 104 through the primary interaction device 100, the primary interaction device 100 can accordingly generate the content information DSCI, which represents the correlations between the actions performed by the user and the digital stream content DSC. Moreover, the action information AI, the content information DSCI, the interaction information II and the user information UI_{—}1, UI_{—}2 are all stored in the data base 106, for allowing the determining unit 112 to perform further analysis. In other words, the digital stream content provider can generate complete analysis data according to the data stored in the data base 106, for acquiring effective information of the user according to the analysis data, so as to provide a unique user experience. For example, the digital stream content provider may acquire favorite types of digital stream contents of the user according to the analysis data, and then the digital stream content provider may push similar types of digital stream content to the user.

The above embodiment utilizes the primary interaction device to display the digital stream content and utilizing the secondary interaction device to perform actions of the interactive network service, so as to allow the user to conveniently interact with others via the interactive network service while watching the digital stream content. Since all the information is uploaded through the primary interaction device, the correlations between the actions of the interactive network service performed by the user and the digital stream content are generated and are stored in the server module. In other words, via the interaction system of the above embodiments, the user can enjoy watching the digital stream content and the digital stream content provider can acquire analysis data which closely represents the real time situation so as to provide a unique user experience. According to different applications, those skilled in the art may accordingly observe appropriate alternations and modifications. For example, the interactive network service corresponding to the digital stream content can be displayed by the primary interaction device and the action of the interactive network service also can be performed by the primary interaction device.

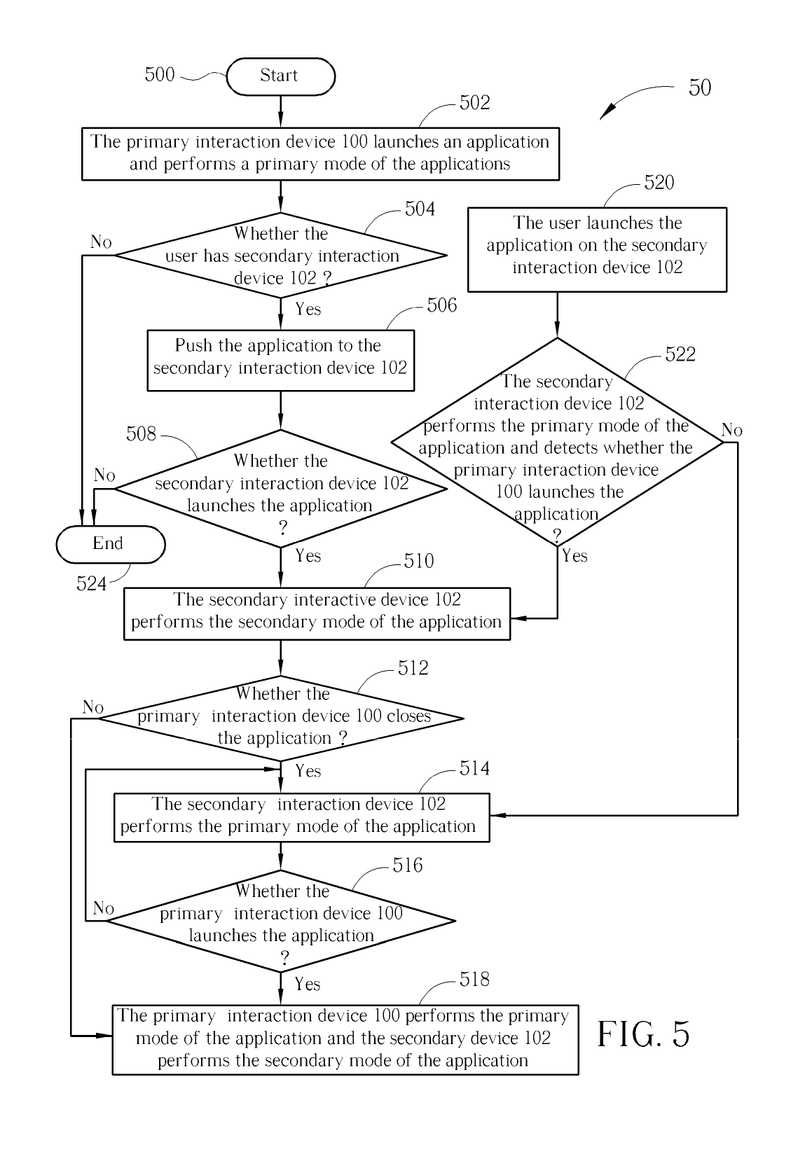

The start procedure 20 may add steps when the interaction system 10 begins to operate, for verifying whether the user wants to perform the interaction mode. Or, the secondary interaction device 102 may firstly launch the application at a time when the interaction system 10 begins to operate. Please refer to FIG. 5, which is a flow chart of a start procedure 50 according to an embodiment of the present invention. The start procedure 50 includes the following steps:

Step 500: Start.

Step 502: The primary interaction device 100 launches an application and performs a primary mode of the applications.

Step 504: Check whether the user has secondary interaction device 102. If the user has the secondary interaction device 102, perform step 506.

Step 506: Push the application to the secondary interaction device 102.

Step 508: Determine whether the secondary interaction device 102 launches the application. Perform step 510 if the secondary interactive device 102 launches the application.

Step 510: The secondary interactive device 102 performs the secondary mode of the application.

Step 512: Detect whether the primary interaction device 100 closes the application. If the primary interaction device 100 closes the application, perform step 514; otherwise, perform step 520.

Step 514: The secondary interaction device 102 performs the primary mode of the application.

Step 516: Detect whether the primary interaction device 100 launches the application. If the primary interaction device 100 launches the application, perform step 518; otherwise, perform step 514.

Step 518: The primary interaction device 100 performs the primary mode of the application and the secondary interaction device 102 performs the secondary mode of the application.

Step 520: The user launches the application on the secondary interaction device 102.

Step 522: The secondary interaction device 102 performs the primary mode of the application and detects whether the primary interaction device 100 launches the application. If the primary interaction device 100 launches the application, perform step 510; otherwise, perform step 514.

Step 524: End.

The detailed descriptions of the start procedure 50 are presented as follows. The steps 500-518 are similar to the steps 200-218 of the start procedure 20 shown in FIG. 2, and thus are not described herein for brevity. Different from the start procedure 20, the start procedure 50 includes steps 520, 522 for the situation where the secondary interaction device 102 can directly perform an application without pushing notifications from the primary interaction device 100. When the secondary interaction device 102 directly performs the application, the secondary interaction device 102 may operate in the primary mode (step 510) or the secondary mode (step 514) of the application via detecting whether the primary interaction device 100 launches the application and operates the primary mode of the application (steps 520, 522).

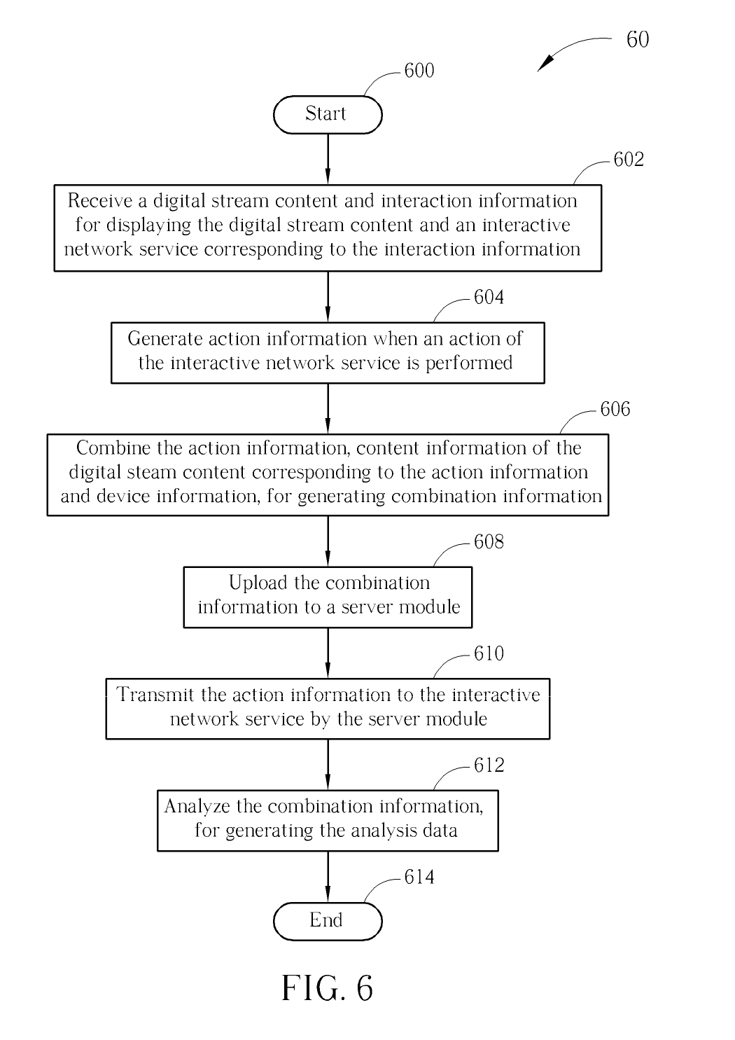

The method of the interactive system 10 acquiring the analysis data can be further summarized to an investigation method 60 as shown in FIG. 6. Please note that the sequence of the investigation method 60 is not limited to the sequence shown in FIG. 6 if a same result can be acquired. The investigation method 60 includes the following steps:

Step 600: Start.

Step 602: Receive a digital stream content and interaction information for displaying the digital stream content and an interactive network service corresponding to the interaction information.

Step 604: Generate action information when an action of the interactive network service is performed.

Step 606: Combine the action information, content information of the digital steam content corresponding to the action information, and device information, for generating combination information.

Step 608: Upload the combination information to a server module.

Step 610: Transmit the action information to the interactive network service by the server module.

Step 612: Analyze the combination information, for generating the analysis data.

Step 614: End.

According to the investigation method 60, the interactions of the interactive network service performed by the user are connected to the digital stream content. Thus, the digital stream content provider can acquire detailed analysis data corresponding to the digital stream content via analyzing the combination information stored in the server module. In addition, the investigation method 60 can further acquire information of the user according to the device information, for jointly analyzing the combination information and the user information. As a result, the analysis data generated by the investigation method 60 can be more symbolic. In addition, the user information can also be acquired from the interactive network service. The detailed operations of the investigation method 60 can be known by referring to the above, and are not narrated herein for brevity.

To sum up, via the interactive system of the above embodiments, the user can use the hand-held secondary interaction device to easily watch information from the interactive network service and perform interactions through the interactive network service. Since the actions of the interactive network service are uploaded to the server module by the primary interaction device, correlations between the actions of the interactive network service and the digital stream content are generated and are stored in the server module. Thus, the analysis data generated according to the information stored in the server module is much closer to the real time experience. In other words, the digital stream content provider can provide a unique user experience according to the analysis data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interaction system, comprising:
a primary interaction device, for receiving a digital stream content and action information and combining the action information, content information of the digital stream content corresponding to the action information and device information to generate combination information;
a secondary interaction device, for receiving interaction information of an interactive network service and performing an action of the interactive network service to generate the action information; and
a server module, comprising:
a data base;
a playing server, for generating the digital stream content; and
a data managing server, for receiving the combination information to transfer the action information to the interactive network service, and storing the combination information and the interaction information in the data base.

2. The interaction system of claim 1, wherein the data managing server acquires user information according to the device information and stores the user information in the data base.

3. The interaction system of claim 1, wherein the data managing server acquires user information from the interactive network service and stores the user information in the data base.

4. The interaction system of claim 1, wherein the action is performed by the primary interaction device and the action information is generated by the primary interaction device.

5. The interaction system of claim 1, wherein the server module further comprises:
a determining unit, for generating analysis data according to the information stored in the data base.

6. The interaction system of claim 1, wherein the content information is playing information of the digital stream content generated while the action information is generated.

7. The interaction system of claim 1, wherein the interaction information is transferred to the secondary interaction device through the data managing server and the primary interaction device.

8. An investigation method of an interaction system for generating analysis data, comprising:
receiving a digital stream content and interaction information for displaying the digital stream content and an interactive network service corresponding to the interaction information;
generating action information when an action of the interactive network service is performed;
combining the action information, content information of the digital steam content corresponding to the action information and device information, for generating combination information;
uploading the combination information to a server module;
transmitting the action information to the interactive network service by the server module; and
analyzing the combination information, for generating the analysis data.

9. The investigation method of claim 8, further comprising:
acquiring user information according to the device information; and
analyzing the combination information and the user information, for generating the analysis data.

10. The investigation method of claim 8, further comprising:
acquiring user information from the interactive network service; and
analyzing the combination information and the user information, for generating the analysis data.

11. The investigation method of claim 8, wherein the content information is playing information of the digital stream content generated while the action information is generated.
